(19) United States
(12) Patent Application Publication
(10) Pub. No.: US 2026/0215409 A1
(43) Pub. Date: Jul. 30, 2026

(54) Modular Rodent Containment Apparatus with Integrated Energy Generation

(71) Applicant: Frank Michael Schöne-de la Nuez, Marburg (DE)

(72) Inventor: Frank Michael Schöne-de la Nuez, Marburg (DE)

(21) Appl. No.: 19/460,383

(22) Filed: Jan. 27, 2026

(30) Foreign Application Priority Data
Jan. 27, 2025 (GB) GB2501160.2

(51) Int. Cl. A01M 23/10; A01M 25/00

(52) U.S. Cl. CPC A01M 23/10; A01M 25/004

(57) ABSTRACT

A modular apparatus for rodent containment and activity management comprises a housing with interconnected chambers, each having an entry gate and an exit gate configured for unidirectional rodent passage. A rotatable mechanism within at least one chamber is configured to be actuated by rodent movement, with an energy conversion system operatively connected to convert mechanical energy into electrical energy. A control system regulates gate operations and energy distribution, ensuring automated functionality. The apparatus includes an incentive dispensing mechanism for providing consumable materials and a passageway system with directional features to prevent rodents from reversing direction. The modular design allows scalability for various environments, and the generated energy supports the apparatus's operations. The invention integrates rodent activity with energy generation while offering controlled containment, making it suitable for urban and industrial applications.

### FIELD OF INVENTION

The present invention relates to humane rodent containment and management systems, specifically devices that integrate energy generation through incentivized rodent activity for scalable deployment in urban and industrial environments.

### BACKGROUND

Rodent infestations in urban and semi-urban areas continue to pose significant health, environmental, and economic challenges. Rats and mice are notorious for their ability to proliferate rapidly, invade human habitats, and adapt to adverse conditions. They are vectors of numerous diseases, including leptospirosis, salmonella, and hantavirus, and can contribute to the spread of these pathogens through their droppings, urine, and direct contact. Their presence also damages food supplies, contaminates storage facilities, and results in structural harm to buildings and urban infrastructure. Despite decades of innovation in pest control, the problem remains persistent and pervasive, particularly in densely populated areas where conventional methods often fall short.

Traditional rodent traps, while effective at eliminating individual rodents, often fail to address the broader issue of long-term population control. Single-use traps, whether mechanical or adhesive, require frequent maintenance and resetting, which makes them labor-intensive and inefficient for large-scale infestations. Poison-based solutions, although widely used, carry significant drawbacks, including the potential for unintended harm to non-target species, environmental contamination, and the risk of rats developing bait aversion or resistance to commonly used poisons. Furthermore, poison-based methods often result in dead rodents in inaccessible areas, leading to secondary issues such as odor and contamination.

Advanced electronic traps and smart pest control systems have attempted to improve efficiency by incorporating automation and remote monitoring capabilities. However, these systems are often expensive, requiring significant initial investment and ongoing maintenance. Many such devices are reliant on external power sources, making them unsuitable for remote or off-grid installations. Additionally, while they may reduce the need for manual intervention, they typically focus on extermination rather than addressing the ecological and behavioral aspects that contribute to rodent infestations. These systems also tend to have limited scalability, making them impractical for widespread use in complex urban environments.

Another challenge lies in the reliance on coercive methods to control rodent behavior. Many existing traps and pest control systems are designed to physically confine or incapacitate rodents, often through mechanical or electrical means. While effective in achieving immediate extermination, these methods fail to utilize the rodents'natural behaviors to enhance the effectiveness of the system. As a result, they do not fully leverage the potential for rodents to contribute to their own management in a way that aligns with sustainable pest control practices.

In addition to their inefficiency, many existing pest control systems offer no secondary benefits, such as energy generation or waste minimization. With growing emphasis on sustainability and resource efficiency, there is a need for solutions that go beyond mere extermination and integrate additional functionalities to create value. For example, the ability to harness energy from rodent activity or utilize modular designs for scalable deployment could transform pest control systems into multi-functional devices that align with modern environmental and economic priorities. These limitations and gaps in existing rodent control solutions underscore the need for a new approach that addresses the shortcomings of traditional systems while offering innovative and sustainable benefits.

It is within this context that the present invention is provided.

### SUMMARY

The present invention provides a modular apparatus for rodent containment and activity management. The apparatus comprises a housing that includes a plurality of interconnected chambers, each equipped with an entry gate and an exit gate configured to permit unidirectional passage of a rodent. A rotatable mechanism, positioned within at least one of the chambers, is configured to be actuated by rodent movement, and an energy conversion system is operatively connected to the rotatable mechanism to convert mechanical energy into electrical energy. The apparatus also includes a control system, which regulates the operation of the gates and manages energy distribution within the apparatus. Additionally, the invention incorporates an incentive dispensing mechanism to encourage rodent movement through the chambers and a passageway system designed to prevent rodents from reversing direction within the apparatus.

The invention offers multiple advantages by integrating rodent activity with energy generation while enabling controlled and scalable containment. The modularity of the design allows for flexible deployment across various environments, including urban and industrial settings. The unidirectional gates and passageways ensure the efficient progression of rodents through the system, while the energy generated can be used to power the apparatus and associated components, reducing the need for external energy sources.

In some embodiments, the rotatable mechanism comprises a running wheel supported on a rotational axis. This configuration allows for efficient transfer of mechanical energy from rodent movement to the energy conversion system, while also serving as a robust activity interface for rodents.

In further embodiments, the energy conversion system comprises a dynamo operatively connected to the rotational axis of the running wheel. The use of a dynamo ensures consistent energy generation during rodent activity and supports self-sustaining operation of the apparatus.

In further embodiments, the control system comprises a microcontroller operatively connected to sensors located within the chambers. The microcontroller processes input from the sensors to regulate gate operations and optimize energy use, ensuring the apparatus operates efficiently and with minimal manual intervention.

In further embodiments, the entry and exit gates are operatively connected to actuators, such as electromagnetic solenoids. These actuators allow for precise control of gate movement, enabling smooth operation while maintaining unidirectional passage for rodents.

In further embodiments, the apparatus includes a storage device, such as a rechargeable battery, for storing the electrical energy generated by the rotatable mechanism. This storage capability allows the apparatus to remain operational even during periods of low rodent activity.

In further embodiments, the incentive dispensing mechanism is configured to provide consumable materials, such as bait or water, to encourage rodent progression through the chambers. In some configurations, the bait includes a slow-acting toxicant to enable population control over an extended period without raising suspicion among the rodents.

In further embodiments, the apparatus incorporates sensors, such as motion or occupancy sensors, to detect rodent activity within the chambers. These sensors enable real-time monitoring and contribute to the automated operation of the apparatus.

In yet further embodiments, the apparatus includes an environmental conditioning system, such as a heating element powered by the energy conversion system, to regulate the internal temperature of the chambers. This feature enhances the attractiveness of the apparatus in colder environments.

In yet further embodiments, the chambers are modularly constructed and removably attachable to one another. This modular design allows the apparatus to be scaled for use in environments of varying sizes and infestation levels.

In yet further embodiments, the passageway system incorporates directional features such as textured surfaces or angled pathways to discourage rodents from reversing direction. This ensures efficient operation by maintaining forward progression through the system.

In yet further embodiments, the apparatus includes a waste collection system to capture debris and excrement produced by rodents during their movement through the chambers. This feature simplifies maintenance and improves hygiene during operation.

### BRIEF DESCRIPTION OF THE DRAWINGS

Various embodiments of the invention are disclosed in the following detailed description and accompanying drawings.

FIG. 1A illustrates an example of the modular system showing the entrance, first chamber, and internal components.

FIG. 1B illustrates an example of the modular system with a rat engaging the running wheel in the first chamber to power gate operations.

FIG. 1C illustrates an example of the modular system with a rat moving into the second chamber through the next chamber gate.

FIG. 1D illustrates an example of the modular system with a rat exiting through the escape passageway and escape gate.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

### Definitions

The terminology used herein is for the purpose of describing particular embodiments only and is not intended to be limiting of the invention.

As used herein, the term “and/or” includes any combinations of one or more of the associated listed items.

As used herein, the singular forms “a,” “an,” and “the” are intended to include the plural forms as well as the singular forms, unless the context clearly indicates otherwise.

It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

When a feature or element is described as being “on” or “directly on” another feature or element, there may or may not be intervening features or elements present. Similarly, when a feature or element is described as being “connected,” “attached,” or “coupled” to another feature or element, there may or may not be intervening features or elements present. The features and elements described with respect to one embodiment can be applied to other embodiments.

The use of spatial terms, such as “under,” “below,” “lower,” “over,” “upper,” etc., is used for ease of explanation to describe the relationship between elements when the apparatus is in its proper orientation.

The terms “first,” “second,” and the like are used to distinguish different elements or features, but these elements or features should not be limited by these terms. A first element or feature described can be referred to as a second element or feature and vice versa without departing from the teachings of the present disclosure.

The term “housing” refers to any structural assembly that defines the physical boundaries of the modular apparatus and supports the internal components, including chambers, passageways, and mechanical systems. The housing may be constructed from durable materials such as stainless steel, high-strength polymer, or reinforced composites, and may include features such as access panels, removable covers, and connection interfaces for modular expansion. In one example implementation, the housing may comprise a rectangular enclosure fabricated from corrosion-resistant stainless steel, with weatherproof seals for deployment in humid or wet environments.

The term “chamber” refers to an enclosed or semi-enclosed section within the housing that is configured to accommodate rodent activity, facilitate specific operations such as energy generation or bait dispensing, and connect to adjacent chambers via passageways. Chambers may vary in size, shape, and material based on their function and placement within the apparatus. In one example implementation, the chambers are cylindrical units with interior walls coated with a non-stick polymer to minimize debris buildup and ensure smooth operation.

The term “rotatable mechanism” refers to any component within the apparatus that is configured to rotate or spin in response to rodent movement. This includes, but is not limited to, running wheels, rotary treadmills, or similar structures supported on an axis. In one example implementation, the rotatable mechanism is a running wheel fabricated from lightweight aluminum, with an anti-slip tread surface to enhance rodent engagement and reduce slippage during rotation.

The term “energy conversion system” refers to any system that transforms mechanical energy generated by the rotatable mechanism into electrical energy. This includes, but is not limited to, dynamos, alternators, or piezoelectric systems. In one example implementation, the energy conversion system includes a compact dynamo with an efficiency rating of 85%, connected to a lithium-ion battery pack for energy storage and distribution.

The term “control system” refers to any hardware or software component that governs the operation of the apparatus, including the regulation of gates, sensors, and energy management. This includes, but is not limited to, microcontrollers, programmable logic controllers (PLCs), and associated firmware. In one example implementation, the control system is a microcontroller-based unit programmed with algorithms to monitor sensor inputs, track running wheel rotations, and trigger gate operations based on predefined thresholds.

The term “incentive dispensing mechanism” refers to any system within the apparatus that provides consumable materials to attract or retain rodents within the chambers. This includes, but is not limited to, dispensers for food, water, or bait containing toxicants. In one example implementation, the incentive dispensing mechanism consists of a gravity-fed bait reservoir made from food-grade polymer, coupled with a solenoid-controlled release valve to dispense pre-measured portions of bait.

The term “passageway system” refers to any structural arrangement that connects the chambers and facilitates controlled movement of rodents through the apparatus. This includes, but is not limited to, tunnels, funnels, or one-way valves designed to prevent backward movement. In one example implementation, the passageway system features angled bristle barriers to discourage reverse motion, with an internal diameter sized to accommodate average rodent dimensions while preventing overcrowding.

The term “gate” refers to any mechanical or electromechanical barrier within the apparatus that regulates entry or exit between chambers. This includes, but is not limited to, sliding doors, spring-loaded flaps, or hinged panels. In one example implementation, the gate is a solenoid-actuated sliding panel constructed from lightweight aluminum, with a smooth operation mechanism to reduce noise and friction.

### DESCRIPTION OF DRAWINGS

The present invention relates to a modular apparatus for rodent containment and activity management that integrates energy generation with automated operational features. By leveraging the natural behaviors of rodents, the invention provides a self-sustaining system that minimizes manual intervention and reduces dependency on external energy sources. The invention is particularly suited for deployment in urban and industrial settings, where large-scale rodent infestations and resource constraints pose significant challenges to existing pest control solutions.

Unlike traditional traps, which rely on single-use mechanisms or hazardous poisons, the invention employs a multi-chambered modular design that encourages voluntary movement of rodents through the system. This approach not only ensures greater containment efficiency but also facilitates energy generation through rotatable mechanisms. By converting the mechanical energy from rodent activity into electrical energy, the system powers its own operations, including gate control, sensors, and incentive dispensing mechanisms, thereby reducing maintenance requirements and operational costs.

The invention further addresses the limitations of conventional pest control methods by incorporating automated features such as sensor-driven monitoring, controlled gate operations, and bait dispensing systems. These features eliminate the need for frequent human oversight while improving containment accuracy and rodent engagement. Additionally, the modular structure allows for scalable deployment, making it adaptable to infestations of varying sizes and complexities.

Another significant advantage of the invention lies in its integration of a unidirectional passageway system, which ensures continuous forward movement of rodents while preventing escape or backtracking. This design improves operational efficiency and ensures that rodents remain engaged with the system, allowing for optimal energy generation and prolonged containment.

By combining rodent containment, energy generation, and automated control in a single apparatus, the invention overcomes the inefficiencies and limitations of prior art systems. It provides a sustainable, scalable, and self-powered solution to rodent management while reducing the environmental and economic impact associated with conventional pest control methods.

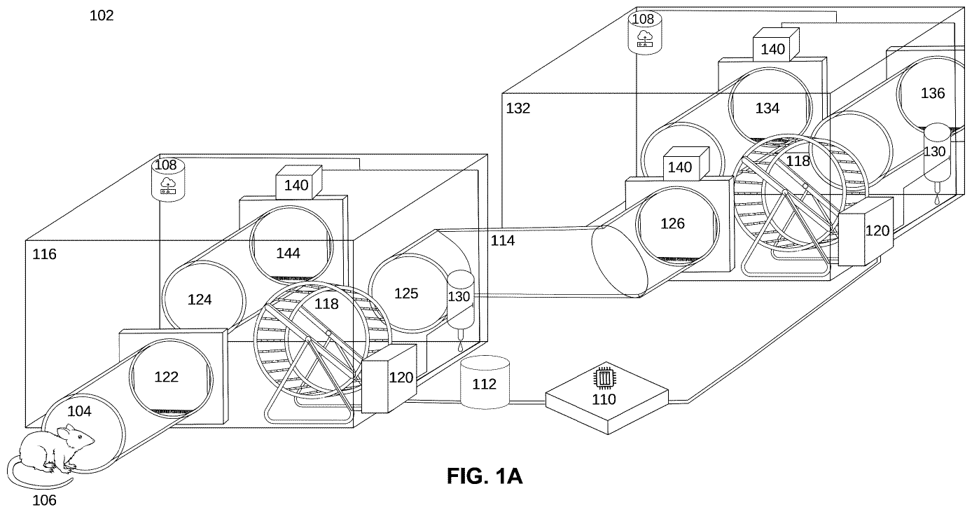

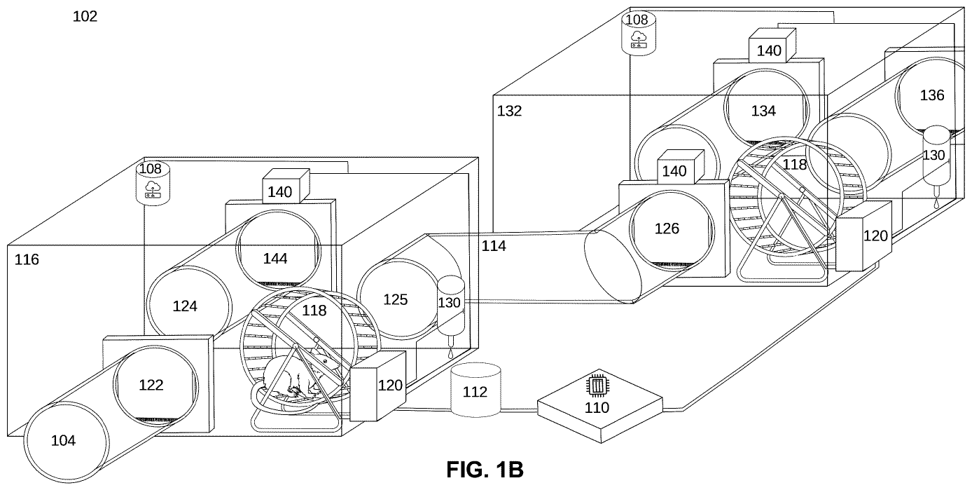

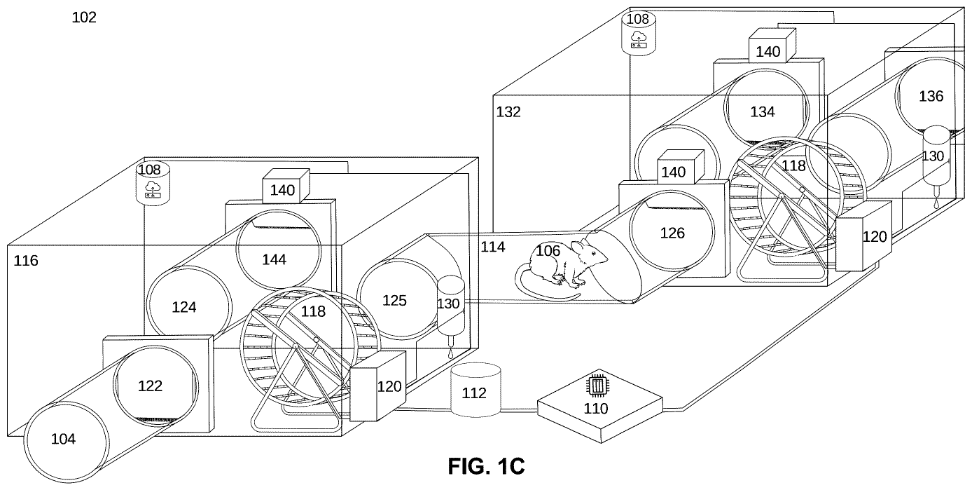

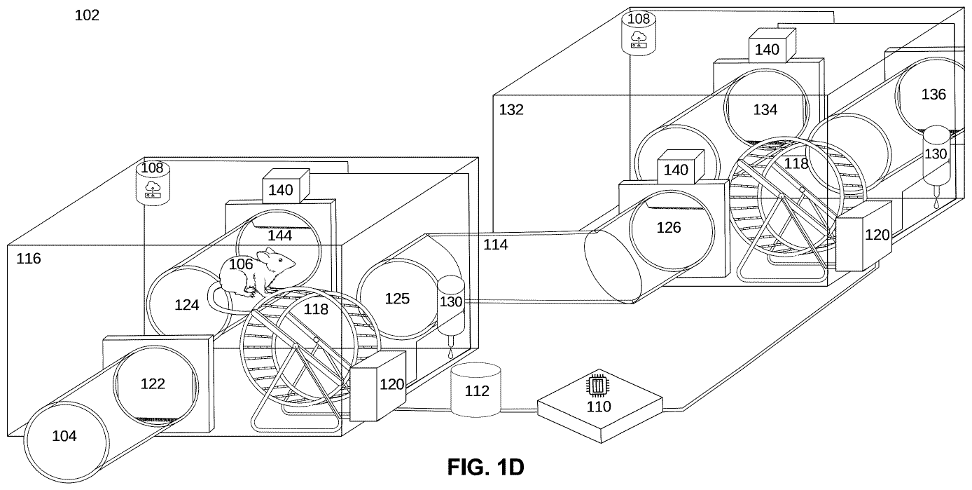

Referring now to the drawings, FIGS. 1A through 1D illustrate a sequence of operations within an example implementation of the modular system 102.

Specifically, the figures show the progression of a rat 106 from its initial entry into the system 102 to various stages of activity and movement through its chambers. The figures collectively depict the structural components, operational mechanisms, and various paths available to the rat 106. System 102 is configured to integrate rodent containment, energy generation, and controlled movement while allowing for scalability and adaptability across different environments.

In FIG. 1A, the system 102 is shown with the entrance 104 providing an access point for the rat 106. The entrance 104 is tubular in design and may include features such as angled bristles or narrowing diameters to prevent the rat 106 from retreating once it enters the system 102. Positioned at the end of the entrance 104 is the entry gate 122, which separates the entrance 104 from the first chamber 116. The entry gate 122 is illustrated as a spring-loaded flap but may also be implemented as a sliding or hinged panel actuated by solenoids, stepper motors, or similar mechanisms.

Within the first chamber 116, FIG. 1A shows the running wheel 118 mounted on a rotational axis. The running wheel 118 is operatively connected to a dynamo 120, which converts the mechanical energy generated by the rat's movement into electrical energy. The dynamo 120 is configured for efficient energy conversion, with the electrical energy stored in the power storage 112. The power storage 112 may for example be a rechargeable battery.

The first chamber 116 also contains two exit tubes leading to a second set of gates: the first exit gate 124 and the next chamber gate 126. The first exit tube 124 leads to the escape passageway 144, while the second exit tube 125 leads to the next chamber gate 126 providing access to the second chamber 132. Both gates are controlled by gate actuators 152, which may be solenoids or stepper motors powered by the energy stored in the power storage 112. The gates are shown as hinged flaps similar to the entry gate but could alternatively be implemented as sliding panels, hinged or pivoting barriers.

The second chamber 132 is structurally similar to the first chamber 116 and includes a running wheel 118, dynamo 120, and sensors 108. The second chamber 132 also contains tubes leading to a second exit gate 134 and an additional chamber gate 136 leading to further chambers in the system 102. The passageway system 114 connecting the chambers may be designed to prevent backtracking by incorporating directional features, such as textured or angled surfaces, which discourage reverse movement.

The incentive dispensers 130 in the first and second chambers provides consumables such as bait or water to encourage the rat 106 to remain engaged with the system 102. In some implementations, the bait dispensed by the incentive dispenser 130 may include slow-acting toxicants to facilitate population control without raising suspicion among the rodents.

Sensors 108, such as motion or occupancy detectors, are strategically placed within the first chamber 116 and second chamber 132 to monitor the presence and activity of the rat 106. The sensors 108 transmit data to the controller 110, which processes the input and regulates gate operations based on predefined parameters.

FIG. 1B illustrates the rat 106 actively engaging with the running wheel 118 in the first chamber 116. As the rat 106 moves the running wheel 118, mechanical energy is generated and converted to electrical energy by the dynamo 120. The generated energy is transmitted to the power storage 112 and distributed to various components of the system 102, including the gate actuators 152 and the sensors 108. The controller 110 tracks the number of rotations of the running wheel 118 using input from the sensors 108. Once a predefined threshold of rotations is reached, the controller 110 signals the gate actuators 152 to unlock and open the first exit gate 124 and the next chamber gate 126, providing the rat 106 with the option to either exit the system 102 or move further into it.

FIG. 1C depicts the rat 106 progressing through the next chamber gate 126 into the second chamber 132.

FIG. 1D illustrates the scenario where the rat 106 chooses to exit the system 102 through the escape gate 144. The escape gate 144 is configured as a one-way flap, ensuring that once the rat 106 exits the system 102, it cannot reenter. The sensors 108 positioned near the escape passageway 144 detect the departure of the rat 106 and transmit an exit signal to the controller 110, which logs the event for monitoring purposes.

### CONCLUSION

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the apparatus of the invention have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A modular apparatus for rodent containment and activity management, comprising:
a housing comprising a plurality of interconnected chambers, each chamber having an entry gate and an exit gate, wherein the entry gate and exit gate are configured to permit unidirectional passage of a rodent;
a rotatable mechanism disposed within at least one of the chambers, the rotatable mechanism configured to be actuated by rodent movement;
an energy conversion system operatively connected to the rotatable mechanism, the energy conversion system configured to convert mechanical energy generated by the rotatable mechanism into electrical energy;
a control system operatively connected to the entry gate, the exit gate, and the energy conversion system, the control system configured to monitor and regulate the operation of the entry gate and the exit gate;
at least one incentive dispensing mechanism disposed within the housing, the incentive dispensing mechanism configured to provide a consumable material;
and a passageway system interconnecting the chambers, the passageway system comprising directional features configured to prevent rodents from reversing direction within the apparatus.

2. The apparatus of claim 1, wherein the rotatable mechanism comprises a running wheel supported on a rotational axis, the running wheel configured to rotate in response to rodent movement.

3. The apparatus of claim 2, wherein the energy conversion system comprises a dynamo operatively connected to the rotational axis of the running wheel.

4. The apparatus of claim 1, wherein the control system comprises a microcontroller, the microcontroller operatively connected to sensors disposed within the chambers, the sensors configured to detect rodent presence or activity.

5. The apparatus of claim 4, wherein the microcontroller is further configured to count the number of rotations of the rotatable mechanism and control the opening and closing of the entry gate and exit gate based on a threshold rotation count.

6. The apparatus of claim 1, wherein the entry gate and exit gate are each operatively connected to an actuator, the actuator configured to move the gate between an open position and a closed position.

7. The apparatus of claim 6, wherein the actuator is an electromagnetic solenoid powered by the energy conversion system.

8. The apparatus of claim 1, wherein the passageway system comprises a unidirectional valve or a spring-loaded flap configured to permit movement of rodents in a single direction.

9. The apparatus of claim 1, further comprising a storage device operatively connected to the energy conversion system, the storage device configured to store electrical energy generated by the rotatable mechanism.

10. The apparatus of claim 9, wherein the storage device is a rechargeable battery.

11. The apparatus of claim 1, wherein the incentive dispensing mechanism comprises a bait dispenser configured to dispense solid or liquid consumable materials.

12. The apparatus of claim 11, wherein the bait dispenser is further configured to dispense consumable materials containing a predetermined quantity of slow-acting toxicant.

13. The apparatus of claim 4, wherein the sensors comprise at least one motion sensor or occupancy sensor disposed within each chamber.

14. The apparatus of claim 13, wherein the sensors are further configured to transmit rodent activity data to the control system.

15. The apparatus of claim 1, further comprising an environmental conditioning system disposed within at least one chamber, the environmental conditioning system configured to regulate temperature.

16. The apparatus of claim 15, wherein the environmental conditioning system comprises an electric heating element powered by the energy conversion system.

17. The apparatus of claim 1, further comprising a communication module operatively connected to the control system, the communication module configured to transmit operational data to an external monitoring device.

18. The apparatus of claim 1, wherein the chambers are modularly constructed and removably attachable to one another, enabling scalability of the apparatus.

19. The apparatus of claim 1, wherein the passageway system further comprises a textured or angled surface configured to discourage rodents from reversing direction within the passageway.

20. The apparatus of claim 1, further comprising a waste collection system disposed within one or more chambers, the waste collection system configured to capture debris or excrement produced by rodents.
